(19) United States
(12) Patent Application Publication
(10) Pub. No.: US 2002/0057948 A1
(43) Pub. Date: May 16, 2002

(54) Multi grouting system

(76) Inventors: Steinar Roald, Tronoheim (NO); Tarald Nomeland, Kristiansand (NO); Zenon Kotelko, Calgary (CA)

Correspondence Address: BLAKE, CASSELS & GRAYDON, LLP, 45 O'CONNOR ST., 20TH FLOOR, OTTAWA, ON, K1P 1A4, CA

(21) Appl. No.: 09/920,321

(22) Filed: Aug. 2, 2001

(30) Foreign Application Priority Data
Aug. 10, 2000 (CA) 2,315,468

(51) Int. Cl. E02D 5/46; C09K 17/00

(52) U.S. Cl. 405/266; 405/258.1; 405/263

(57) ABSTRACT

Discloses cementitious materials for treatment of underground or subterranean formations to reduce formation porosity for the control and of subterranean fluid flow as well as methods of applying the cementitous materials to the underground formations. The cementitious materials include both ordinary Portland cement and magnesium oxychloride cement which act co-operatively to produce a low permeability zone in the underground formation. Application methods describing injection of the cementitous materials into the underground formation to be treated are disclosed for treatment of pre-excavation formations and post excavation formations. Describes use of the cementitious materials and methods of application in relation to underground tunnel and roadway construction as well as foundation treatment of dam structures for water reservoirs.

### BACKGROUND

This invention relates to a multi-grouting system and in particular the cementitious materials used and methodologies employed to control fluid flow in underground formations. More particularly, this invention relates to grouts of ordinary Portland cement and magnesium oxychloride cement for the creation of a low permeability barrier or zone to seal underground formations, such as rock and the like, from fluid flow.

### BACKGROUND TO THE INVENTION

Underground construction includes but is not limited to the creation of structures such as tunnels used for road and rail transportation; subway transportation in urban areas; utilities; underground storage for water, hydrocarbons and waste; hydroelectric power plants. Many construction methods are used for this type of construction to create these types of structures. One method is known as the Norwegian Tunnelling Method (NTM). NTM involves drilling and blasting hard rock. Another method is known as the New Austrian Tunnelling Method (NATM). NATM involves traditional excavation methods with structural support in softer sedimentary rock and soils. Tunnel boring machines (TBM) are also widely used in all rock types. The finished structure construction may include concrete or membrane lining; sprayed concrete for structural support; and steel rib lining, rock bolts and anchors.

The control of subterranean fluid flow, both during construction of a structure and after the structure is completed, is important for a number of reasons including but not limited to the cost of handling the fluid after the structure is constructed and the cost to maintain the groundwater level, especially in urban situations. The ability to locate, penetrate and seal earthen fractures and pores which enable subterranean fluid flows is essential for overall management of a subterranean construction project as well as the utility and integrity of the structure following construction.

In the past, underground grouting has been employed to control and to constrain subterranean fluid flows. One type of underground grouting practice is to inject cementitious grouts and chemical grouts into the subterranean formation. A number of different products and practices have been utilised in underground grouting to control subterranean fluid flows. Heretofore, the majority of the cementitious grout used is ordinary Portland cement (OPC). Other products have also been used including chemical grouts, such as: poly-urethanes, acrylamides and epoxy resins. Chemical grouts are desirable because they do not contain particulate materials and, therefore, have the ability to penetrate fine cracks and pores. In addition, chemical grouts are desirable because they provide for fast and controlled setting or curing times. While chemical grouts have several desirable properties, use of chemical grouts also introduces the potential for several problems. The problems can occur when the chemical grouts are used alone and also can occur when the chemical grouts are used in combination with cementitious grouts. When chemical grouts are combined with cementitious grouts, the higher pH (basic) of the cementitious grouts intermixing with the chemical grouts can cause the chemical gels of the chemical grouts to become destabilised due to the lower pH (acidic) of chemical gels.

In addition to chemical grout stability problems, tighter environmental considerations and safety concerns is leading to more restricted use and more restrictions on the use of chemical grouts. For example, there is an increasing concern to protect groundwater and potable water from exposure to certain chemical grouts. In addition, application of chemical grouts raises handling, storage and worker exposure issues in the operations to effect grouting during construction where the health and safety of workers is a paramount concern.

### SUMMARY OF THE INVENTION

This invention provides a new generation grouting system to replace previous industry practices in relation to using chemical grouts. This invention also provides a flexibility of choice using inert, safe grouts during construction, which can save time and ultimately reduce the cost of the construction.

The invention uses only materials that are safe for the workers and the environment. In particular, this invention relates to mixtures and methods of application of ordinary Portland cement (OPC), magnesium oxychloride cement (MOC) and silica fume (SF).

The term OPC is intended to include all particle sizes and includes OPC ground down to an average particle size of less than ten microns. OPC particles ground down to average particle sizes of less than ten microns is also known as micro fine or ultra fine cement and is some times denoted as M-OPC. The micro fine or ultra fine OPC or M-OPC is particularly well suited for penetration of fine cracks of less than one-half millimeter in cross-sectional dimension. In this specification, the terms OPC and M-OPC are used interchangeably in the discussion of the invention. An OPC slurry is formed by mixing the OPC with water prior to injection placement in the subterranean formation. Preferably, the water OPC cement ratio ranges from 1:4 to 6:1 by volume for optimum performance. In the preferred embodiment, the slurry includes SF to aid in penetrating the surrounding media and to contribute to the durability and mechanical strength of the OPC when it cures. The SF is present in the slurry in quantities of up to eighty percent by weight of the OPC. Other additives can also be included in the slurry to control bleeding, particle segregation and the Theological properties of the slurry.

An MOC slurry is formed by mixing the MOC with water prior to placement in the subterranean formation. The OPC and MOC slurries are placed in the subterranean formation to form a low permeability zone (LPZ) in the formation to control or to prevent the flow of fluid through the formation as a consequence of the introduction of the LPZ into the formation. The LPZ is established by the injection placement of the OPC and MOC slurries in the formation. We have found that when the slurries of the OPC and the MOC are in contact with each other, they interact synergistically with each other to accelerate the curing or setting of each other. Thus, the MOC slurry is utilised to control the slurry setting or curing time and to control the slurry rheology and, further, to induce high early strength development of the LPZ. In the MOC slurry, preferably the water MOC cement ratio ranges from 1:4 to 6:1 by volume depending on the application.

The MOC slurry preferably includes SF. As with the OPC slurry, SF is included in the MOC slurry to aid in slurry penetration into the surrounding media. The presence of SF in the slurry also contributes to the durability and mechanical strength of the MOC. The SF is used in the MOC slurry in proportion quantities of up to eighty percent by weight of the MOC.

A slurry material is injected into the formation to form an LPZ or barrier via pre-drilled spacedly disposed infiltration holes or bores in the vicinity of the subterranean formation or volume to be treated. Injector tubing is inserted to a predetermined location successively in each of the bores. Once inserted into the bore, the injector tubing is sealed in location by a releasable packer, for example an inflatable packer, and the selected slurry material is then supplied under pressure to the formation.

In one of its aspects, the invention provides a method of treating a subterranean formation comprising: forming at least one bore extending into a subterranean formation and supplying under pressure a magnesium oxychloride cementitious grout slurry to each bore. Then forming a correspondingly disposed bore for of these bores and supplying under pressure an ordinary Porland cementitious grout slurry to each correspondingly disposed bore.

In another of its aspects, the invention provides a method of producing a low permeability zone in a subterranean formation surrounding a volume for excavation comprising: forming a plurality of bores extending into a subterranean formation, surrounding and extending outwardly a first selected distance from a predefined volume and supplying under pressure a magnesium oxychloride cementitious grout slurry to each bore. Next excavating a selected distance into the portion of said subterranean formation surrounded by the bores to an excavation front which is not more than one half of the depth of the bores, then, at the excavation front, forming a correspondingly disposed second bore for each previously grouted bore. Each correspondingly disposed second bore extends into the subterranean formation surrounding and extending outwardly a second selected distance from the predefined volume, which second selected distance is less than said first selected distance. Followed by supplying under pressure an ordinary Portland cementitious grout slurry to each said correspondingly disposed second bore.

In yet another of its aspects, the invention provides a method of producing a low permeability zone in a subterranean formation surrounding an excavated volume comprising forming a plurality of bores extending into a subterranean formation, surrounding and extending outwardly a first selected distance from the excavated volume. Next a magnesium oxychloride cementitious grout slurry is supplied under pressure to each bore. Then, longitudinally displaced a selected distance along said excavation from the previously formed bores, which is not more than one half of the depth of those bores, forming a correspondingly disposed bore for each of the previously formed bores. The correspondingly disposed bores extend into the subterranean formation surrounding and extending outwardly a second selected distance from the excavation, which second selected distance is greater than the first selected distance. Then supplying under pressure an ordinary Portland cementitious grout slurry to each correspondingly disposed bore.

In yet another of its aspects, the invention provides a mixture for treatment of a subterranean formation comprising: a first slurry of ordinary Portland grout produced from mixing water and ordinary Portland cement mixed in a ratio of 1:4 to 6:1 by volume; mixed with a second slurry of magnesium oxychloride grout produced from mixing water and magnesium oxychloride cement mixed in a ratio of 1:4 to 6:1 by volume.

And in yet another of its aspects, the invention provides a method of creating a low permeability zone in a subterranean formation containing water under pressure comprising: forming a bore into the formation; supplying under pressure a volume of an ordinary Portland cementitious grout slurry to the bore; and supplying under pressure a substantially similar volume of a magnesium oxychloride cementitious grout slurry to the bore.

The preferred embodiments of the invention will now be described with reference to the attached drawings in which like reference numerals are used to denote like features of the invention throughout the various figures.

### BRIEF DESCRIPTION OF THE DRAWINGS

FIG. 1 is a cross section of a subterranean formation in which excavation is to take place depicting injection bores that will be used to supply grouting material to the formation in accordance with the principles of the invention.

FIG. 2 is a side view of a functional diagram of the equipment used to pressurise and to inject grouting material into a formation.

FIG. 3 is a cross section of the subterranean formation of FIG. 1 depicting dispersion of MOC grouting material into the formation from the injection bores of FIG. 1.

FIG. 4 is a cross section of a subterranean formation prior to excavation and as excavation progresses depicting injection bores that will be used to supply a second grouting material to the formation in accordance with the principles of the invention.

FIG. 5 is a cross section of the subterranean formation of FIG. 4 depicting dispersion of OPC grouting material into the formation from the injection bores of FIG. 4.

FIG. 6 is a cross section of a subterranean formation showing the dispersion and intermixing of a multi-grout injection.

FIG. 7 is a longitudinal cross section of a subterranean formation depicting injection bores and grout dispersion in the formation as an excavation progresses through the formation in accordance with the principles of the invention.

FIG. 8 is a longitudinal cross-section of a tunnel structure, showing a post-tunnel-construction establishment of a low permeability zone in the formation in accordance with the principles of the invention.

FIG. 9 is a cross section of an excavated subterranean formation depicting injection bores that will be used to supply a first grouting material to the formation in accordance with the principles of the invention.

FIG. 10 is a cross section of the excavated subterranean formation of FIG. 9 depicting dispersion of MOC grouting material into the formation from the injection bores of FIG. 9.

FIG. 11 is a cross section of an excavated subterranean formation depicting injection bores that will be used to supply a second grouting material, OPC to the formation in accordance with the principles of the invention.

FIG. 12 is a cross section of the subterranean formation of FIG. 11 depicting dispersion of the second grouting material into the formation from the injection bores of FIG. 11.

FIG. 13 is a cross section of a river bed formation depicting a bore hole placement to enable a first grout material injection below a dam berm which is to be constructed thereover.

FIG. 14 is a top view of the river bed formation of FIG. 13 showing dispersion of a first grout material and bore hole placement to enable a second grout material injection below a dam berm which is to be constructed thereover.

FIG. 15 is a side cross section of the river bed formation of FIG. 14 showing dispersion of first and second grout materials below a dam berm.

### DETAILED DESCRIPTION OF THE PREFERRED EMBODIMENT

The system of the present invention can be used in subterranean construction both before and after excavation occurs. Specific applications of the system are described for construction before excavation occurs, which is referred to as a pre-grouting application and after excavation occurs, which is referred to as a post-grouting application.

1. Pre-grouting Application

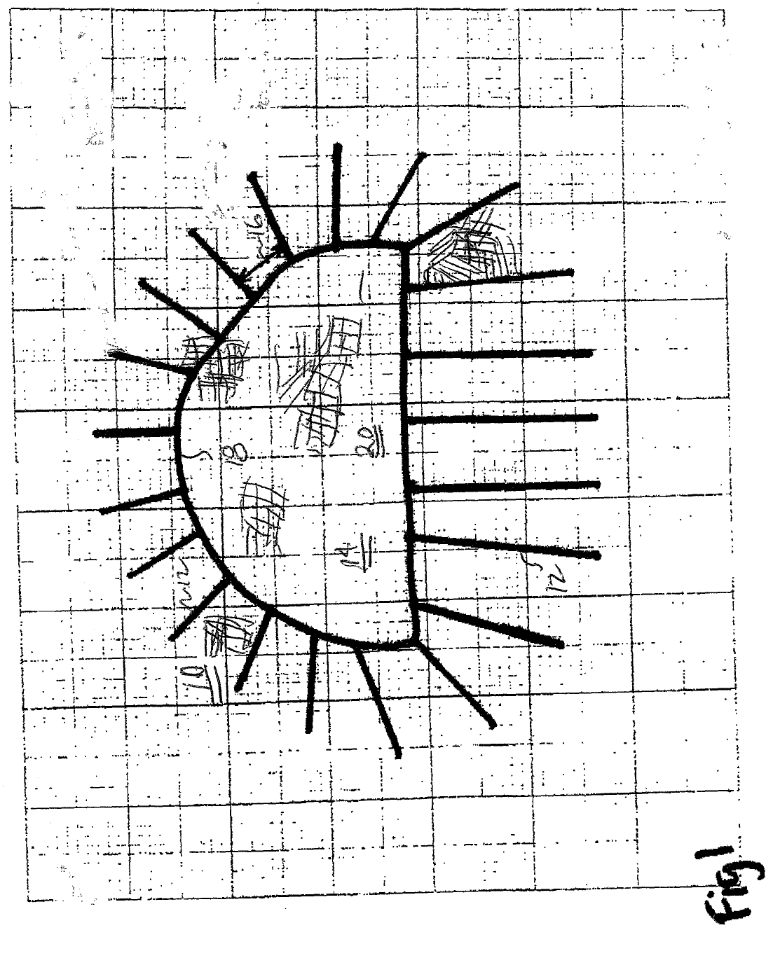

FIG. 1 shows a cross section of a profile of a subterranean tunnel which is planned to be excavated from an earthen formation. In a pre-grouting application, a grouting slurry is applied to the volume surrounding that in which the tunnel will be excavated to establish a low permeability zone in the volume surrounding the planned excavation. The low permeability zone will be established to seal the rock fractures and reduce porosity of the formation. The grouting is supplied to the formation, generally depicted by reference numeral 10, via holes or bores 12 which are drilled into the formation. In the pre-grouting application, all bores or holes 12 are drilled ahead of the excavation area 14 of the construction zone. The hole spacing 16 is selected to allow for pressure injection application of the grouting slurry materials into the formation through holes 12 to enable the pre-grouting to be applied to establish a sufficient thickness to reduce or to prevent subsequent water leakage into the tunnel excavation 14. The pre-grouting has a two fold purpose. The first purpose is to create a uniform low permeability zone in the earthen formation that will remain after tunnel excavation. After tunnel excavation, a tunnel wall 18 will define a boundary between the tunnel structure forming tunnel passage 20 and the formation 10 that surrounds it. At the time when holes 12 are bored, tunnel wall 18 is only a theoretical wall or boundary in formation 10. The thickness of the low permeability zone that will be established by the application of the grouting material is determined by the need to establish a uniform pressure gradient throughout the low permeability zone. The second purpose of pre-grouting is to seal the volume in front of where the tunnel excavation construction will occur to prevent leakage of water during tunnel construction.

Pre-grouting during underground construction involves drilling of holes 12 into all the surrounding rock faces i.e. front, walls, ceiling and floor that will be created by the excavation construction. The number of holes 12 that are to be drilled will naturally depend on the perimeter or length of the boundary that defines the tunnel wall 18 as well as on the earthen material found in the formation. Because injection pressures can range from 30 to 70 bar, it is preferable to ensure that the spacing 16 between adjacent holes at the tunnel wall 18 is not less than 0.4 meters to ensure that sufficient formation material is present between adjacent bores to withstand the forces created by the injection pressures. Once holes 12 are drilled, grout material is injected under pressure to establish a low porosity zone to seal cracks and reduce formation porosity which will act to minimise the inflow of water. Injection of the grout material also acts to consolidate the rock formation and improve its structural integrity. Thus pre-grouting will further stabilise the subterranean formation proximal to the tunnel surface and, consequently, the tunnel structure (not shown) constructed in the tunnel passageway 20 may require less structural support as a result.

This invention employs specific methodology relating to a multi-grout pre-grouting system. Use of the methodology results in the creation of a uniform low permeability zone in the treated volume of the formation. The actual grouting procedure employed will depend on the characteristics or type of materials found in the formation and the formation in-situ permeability. The formation characteristics and proposed construction will dictate the actual drill pattern and type of materials required to create this uniform low permeability zone.

In a pre-grouting procedure, injection holes 12 are drilled all around the intended perimeter of the construction, for example a tunnel. The holes 12 are drilled to a length extending from four to fifty meters. The holes 12 are drilled at different angles, or fan out direction, that depends on the local formation conditions. The holes 12 are of a length sufficient to enable grouting material supplied therethrough to create the uniform low permeability zone in the formation of the thickness required to minimise fluid flows into the construction. In practice, it is expected to drill a total of five to sixty holes depending on the formation permeability, formation water pressure and the desired or permitted leakage. The injection holes 12 are spaced approximately not less than forty centimeters apart into the front and along the future theoretical wall 18. The drilling along the future theoretical wall creates a ring or round around the entire circumference of the tunnel. Once the holes 12 are drilled, injection can start. For best results, injection can start at the bottom of the tunnel, but this can vary depending on local conditions.

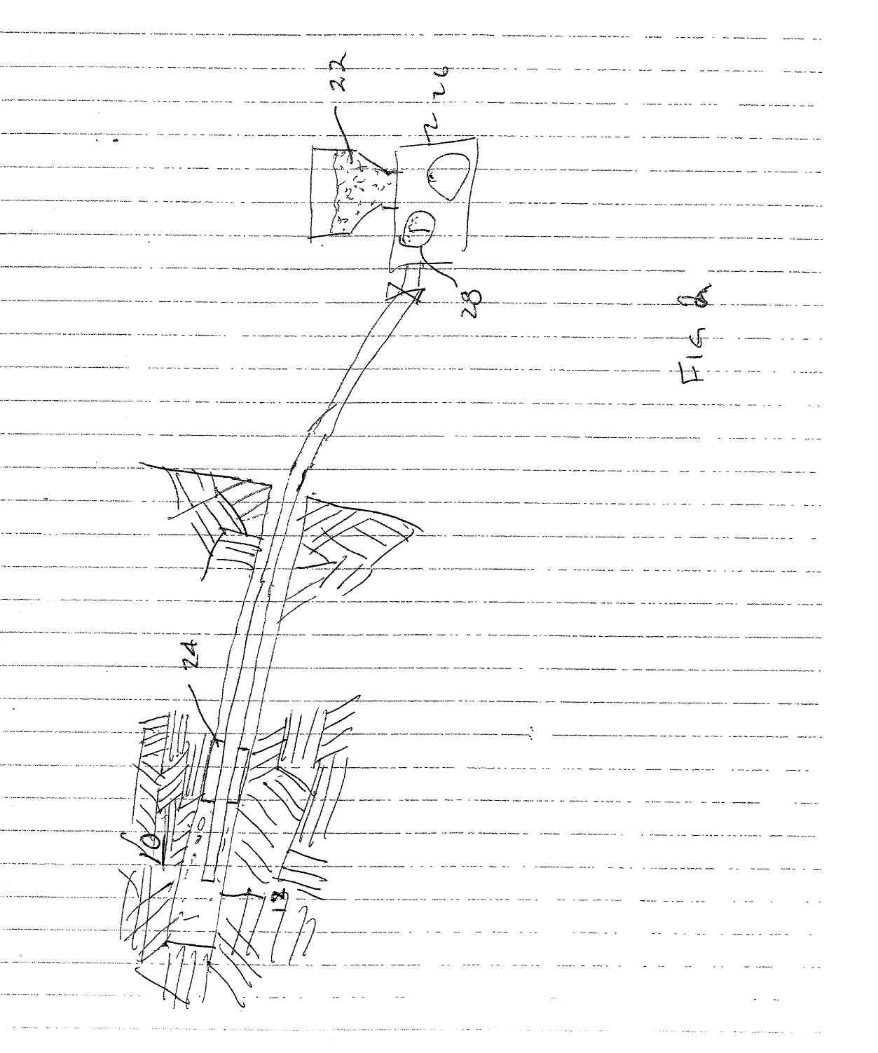

Referring to FIG. 2, a first grout mixture 22 of MOC with a water cement ratio of 1:1 to 2:1 forms a slurry which is injected into the grout lines or bores 12. A first slurry of the grout mixture is injected into the bore 12 behind an expandable seal 24, such as an inflatable packer, to supply the pressurized grout slurry to the formation being treated. The pressurized grout slurry is supplied from a slurry pump 26. A pressure gauge 28 is preferably provided to monitor the injection back pressure which typically ranges from 30 to 70 bar.

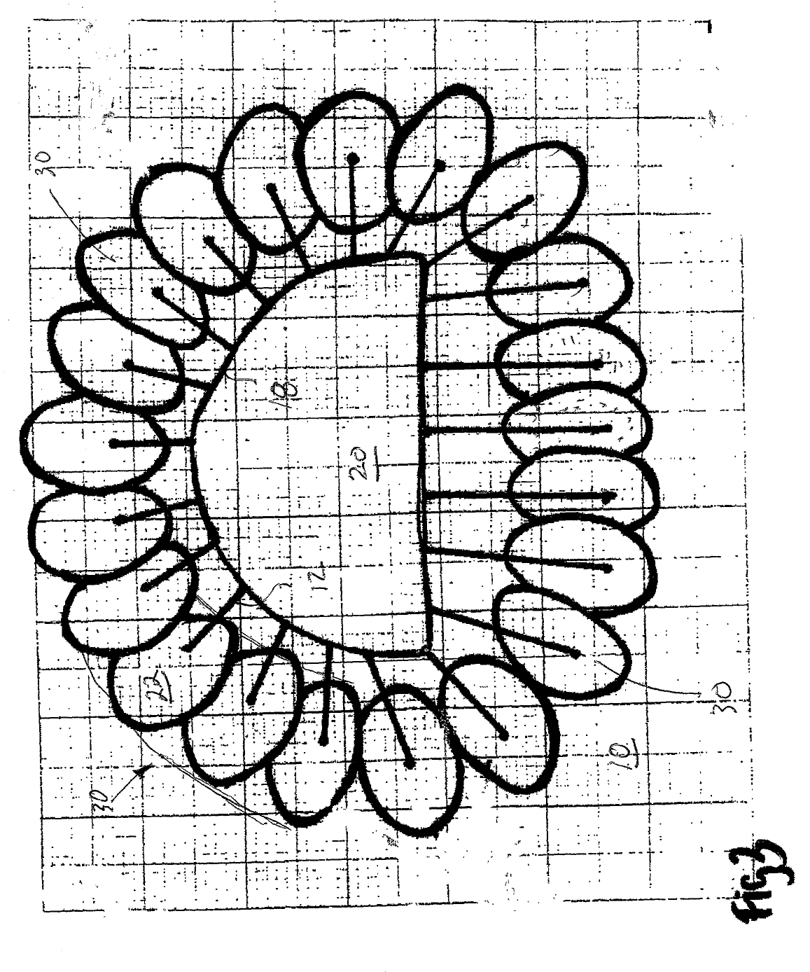

FIG. 3 shows a the slurry dispersion of the first round of injection. The first round of injection of the MOC slurry establishes a perimeter low permeability zone 30 that extends outwardly twenty to thirty meters from the perimeter or theoretical wall 18 of the tunnel that is to be constructed.

The perimeter low permeability zone 30 confines the dispersion of the next round of grouting nearer to the construction zone. This results in less grout being used in the next round of grouting as the grout slurry of the second round will not be injected too far away. The perimeter low permeability zone 30 also establishes a boundary region in the formation to create the necessary back pressure required to allow the injection and sealing of all fine cracks and porosity proximal to the intended excavation to better ensure that the second round of grouting establishes a low permeability zone having a watertight construction.

The controlled setting characteristics, obtained by the first round injection of the MOC slurry, enables the second round of grouting, which commences with injection of a micro fine or ultra fine OPC slurry inside the perimeter low permeability zone 30, to start with minimal delay. When the first round injection of the MOC slurries has had enough time to cure to establish sufficient strength development (usually within two hours) the second round of injection incorporating a micro fine or ultra file OPC slurry can begin.

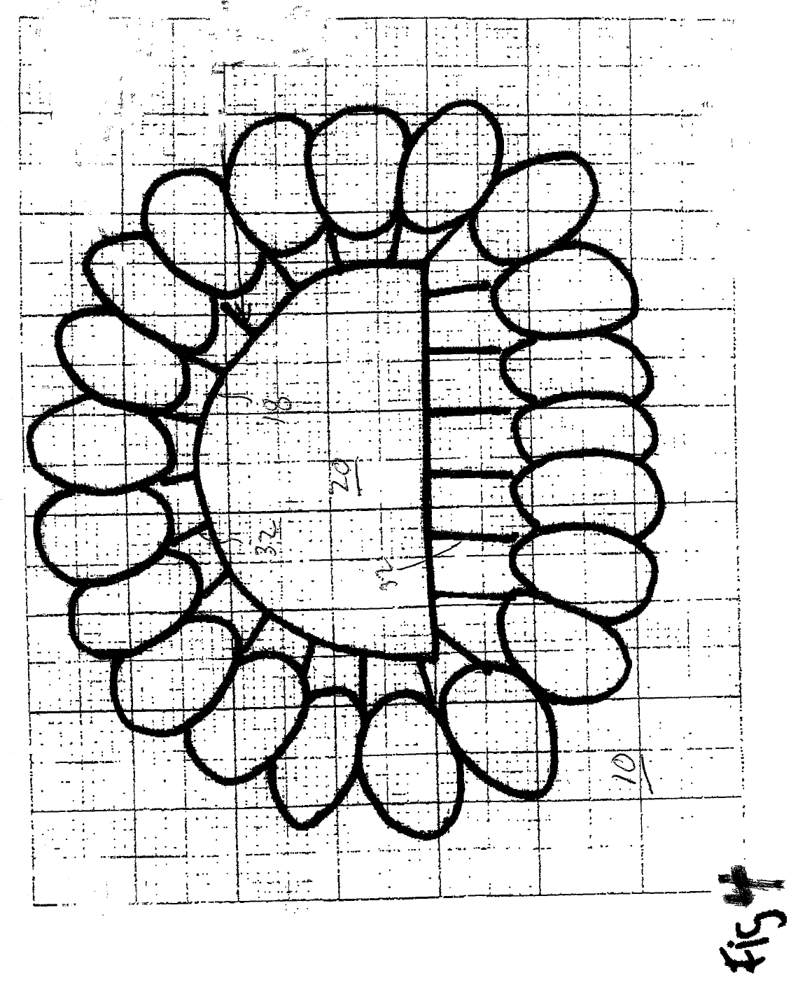

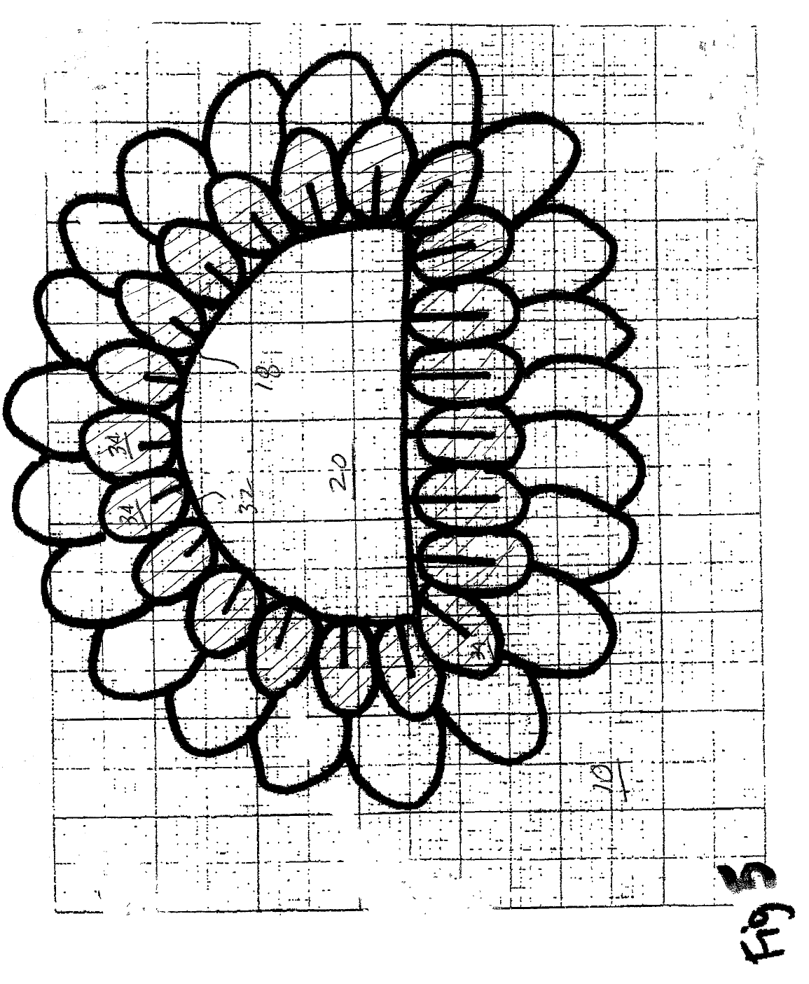

FIG. 4 shows the set up for the second round of injection. To commence the second round injection, additional holes 32 are drilled in an offsetting pattern from the holes 12 of the first injection round. The second round injection holes 32 preferably have a depth that is two to three meters less than the depth of the first round injection holes 12 which were drilled to create the perimeter low permeability zone. It is preferable to begin injection of the grouting at the bottom of the construction zone and progress systematically upwards to the top of the construction zone. Injection of the OPC grouting slurry will cause the slurry to diffuse or permeate into the formation, as shown at 34. Injection of the micro fine or ultra fine OPC slurry continues until a predetermined pressure or refusal rate is achieved.

Once the volume forming the uniform low permeability zone surrounding the proposed excavation has been grouted with the OPC slurry, an MOC slurry grouting material is next injected into the bores 32. The purpose of this final filling with an MOC slurry is to accelerate the curing or setting of the injected OPC slurry 30. When the MOC slurry is injected into the bores 32, it will intermix with the previously injected OPC slurry. The intermixing of the slurries will induce accelerated curing or setting or hardening which will reduce the time needed before the OPC slurry is prevented from being expelled back out of the injection holes 32. Consequently, tunnelling excavation operations can be undertaken or can resume with reduced downtime.

If significant water inflow is encountered during the drilling of the injection holes, 12 or 32, a sequential injection of an OPC slurry followed by an injection of an MOC slurry into each hole or bore 12 is used. This sequential drill/injection procedure preferably utilises two slurry pumps 26, one for the MOC and the other for the OPC. It is preferable to have two slurry pumps on hand in any event to avoid the repeated need to clean and set up the slurry pump each time. This procedure may need to be repeated several times to allow the acceleration of the setting of the two grouts to fill and seal the water producing fracture. Additional graded sized fillers including sand may also be included in the slurry in conjunction with the grouting procedures to stem water inflow.

The resulting effect of this system will be a low permeability overlapping seal of the tunnel effective both during and after tunnel excavation or construction.

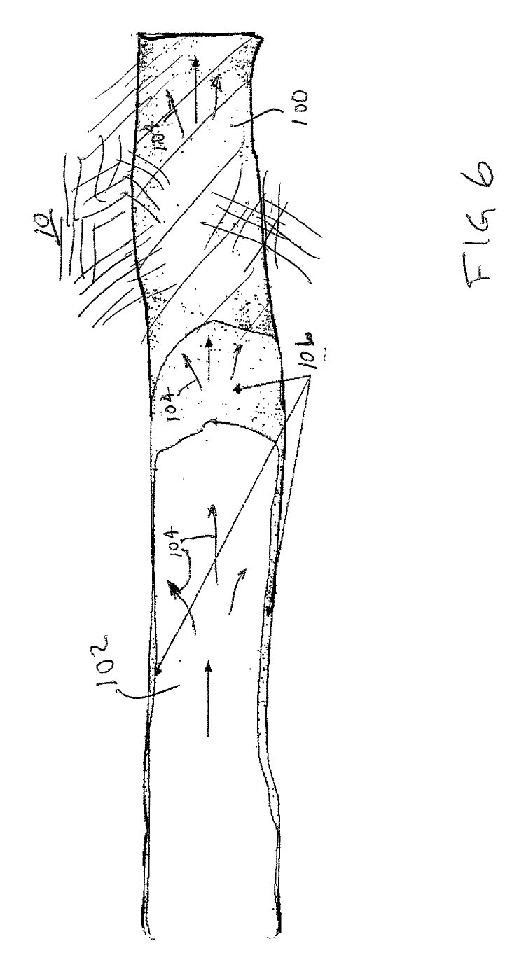

FIG. 6 shows a profile of a formation 10, a portion of which has been permeated with an OPC slurry 100. Another portion of the formation has been permeated with an MOC slurry 102. The general direction of flow of the slurry is depicted by arrows 104. In the arrangement of FIG. 6, first the OPC slurry 100 is injected into the formation 10 where it is dispersed or permeated into the formation 10. Next an MOC slurry 102 is injected into the formation where it too is dispersed or permeated into the formation, generally in the direction of arrows 104. A contact zone 106 is produced which has intermixing of the OPC and MOC slurries. The slurries are intermixed in the region of contact zone 106 as the MOC slurry is injected into the formation 10 following the OPC slurry injection. The intermixed slurries of the contact zone 106 undergo an acceleration of the stiffening or curing of the cementitious materials which results in a decreased reaction time or setting of the concrete than would be achieved by using either MOC or OPC cement alone.

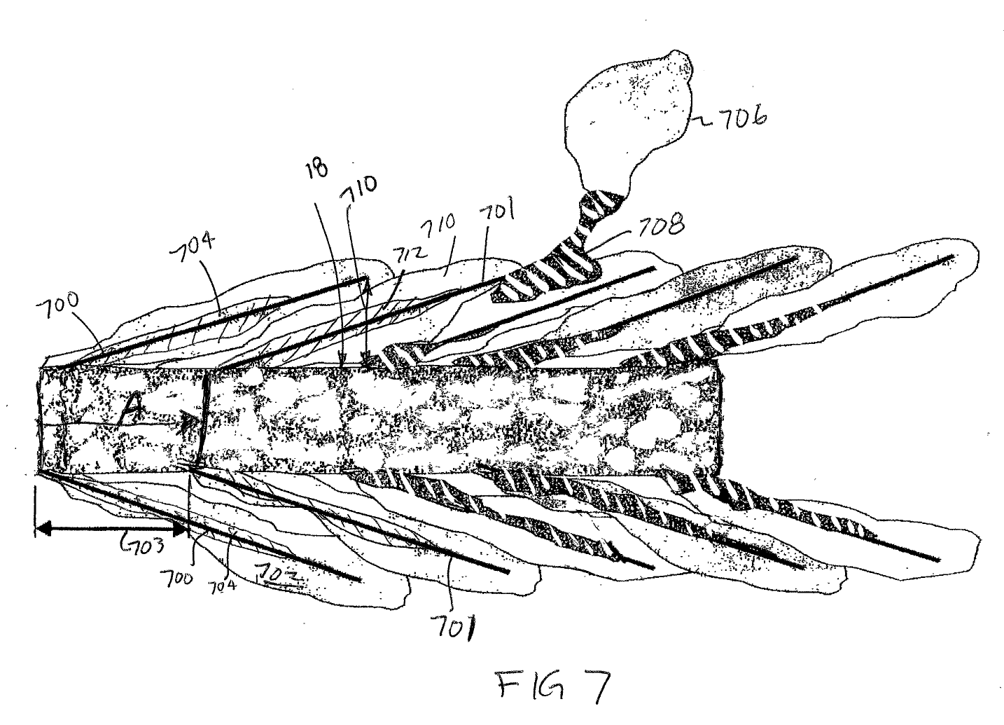

FIG. 7 shows five successive grouting rounds by way of example. For ease of understanding, the formation itself has not been detailed in FIG. 7. A first set of grouting bores 700 is drilled into the formation. Each of the bores 700 is directed or inclined outwardly, or fanned out, from the direction of excavation, typically by approximately 3 to 15 meters from the tunnel theoretical wall 18 as measured from the end of the bore to the tunnel theoretical wall. The fan-out measurement is denoted by double headed arrow 710. An OPC slurry is injected into the bores where it diffuses or permeates into the formation in the vicinity of the bore as at 702. Subsequently, an MOC slurry is injected into the bore where it diffuses or permeates into the formation into the vicinity of the bore as at 704. As explained with reference to FIG. 6, the introduction of the MOC slurry will cause an intermixing contact zone to be established between the OPC and MOC slurries that will result in an accelerated setting time of the slurry to thereby lessen the time that would otherwise be required to seal bore 700 against back flow of the slurries 702, 704 out of the bore 706.

As mentioned previously with reference to FIG. 1, a low injection pressure occurs when large formation voids or fissures or fractures contribute to runaway grout diffusion. Little or no back-pressure during the first OPC slurry injection indicates the presence of larger fractures or voids in the formation which is exemplified in FIG. 7. Such larger fractures or voids need to be filled before an injection to establish a low permeability zone by treatment of the finer cracks that affect formation porosity can be carried out. When formation voids are present, the first injection of an OPC grouting slurry will readily tend to expel into the larger fractures or voids, as shown by 706 and, when cured, the grout will act to stabilise and to seal such larger fractures or voids. To complete the filling and sealing of larger fractures or voids, when they are present, a grout mixture of MOC, 708 of FIG. 7, is next injected into the drill hole. The second slurry, namely the MOC slurry then is injected into the formation and the MOC slurry tends also to diffuse toward the formation void as depicted at 708. Due to the intermixing of the MOC slurry with the OPC slurry, a decrease in initial setting time to produce a stiffened or hardened slurry can be obtained in as little as two hours.

Once the larger fractures or voids in the formation have been grouted, an OPC slurry is subsequently injected into the formation as at 710, to continue the establishment of a low permeability zone. Following injection of the OPC slurry, a finishing round MOC slurry is injected as at 712. When the slurries injected into the first set of bores 700 has set, excavation of the formation to the next tunnel face can proceed as depicted by the arrow labelled “A”. The depth of penetration into the formation preferably provides a 50% overlap of successive bores 700 and 701. In other words, the distance 703 spanned between successive bores preferably should be such that the entry point of bores 701 is not more than one half the depth that the bores 700, 701 are drilled into the formation.

FIG. 8 shows a longitudinal cross-section of a tunnel structure, the formation surrounding which has a low permeability zone established in accordance with the principles of the invention. This figure shows the stages of construction and excavation that employ the pre-grout type of grout injection system that utilised before excavation construction of a subterranean facility such as a tunnel, the passage of which is shown as 20 in the figure. The pre-excavation grouting of the formation is effected to seal formation fractures and to reduce formation porosity which will reduce or eliminate water leakage into the excavation.

FIG. 8 shows a cross section of a formation into which a tunnel 20 has been excavated. Pre-excavation grouting of the tunnel construction is carried out by drilling a set of holes 12 into the ground wall 11 into the formation at all of the proposed tunnel passage surrounding faces, that is, the walls, ceiling and floor of the to be constructed tunnel passage 20. The set of bores or holes 12 are drilled to receive an injection of an MOC slurry material. Length wise cross sections of the bores 12 are shown in FIG. 8. As well, the bore entry points of holes 12 drilled into the floor of the tunnel are visible in the figure. This set of holes 12 is drilled in the formation to receive a first round injection of an OPC slurry. The OPC slurry will diffuse into the formation, as at 22, to commence establishment a perimeter low permeability zone 30 in the formation. In practice, the outer limit of the perimeter low permeability zone 30 can extend outwardly twenty to thirty meters from walls, ceiling and floor of the tunnel passage 20.

Excavation of the tunnel passage is then performed to the location where a second set of holes 32 is then drilled into the formation again at the tunnel passage 20 surrounding faces, that is, the walls, ceiling and floor of the tunnel passage. The second set of holes 32 are drilled in an offsetting pattern relative to the first set of holes 12. The second set of holes 32 have a length at least two to three meters less than the length of the first set of holes 12. The second set of injection holes 32 is preferably spaced approximately five meters from each adjacent set of holes 12 in the longitudinal direction, that is, along the length of the tunnel passage 20. To accomplish this, it will be understood that excavation of the tunnel passage 20 which was performed to the location where the second set of hole 32 is drilled would advance the tunnel construction by the adjacent hole spacing of five meters. Length wise cross sections of the bores 32 are shown in FIG. 8 as well as the bore entry points of holes 32 that were drilled into the floor of the tunnel passage 20 are visible in the figure. This second set of holes 32 is drilled in the formation to receive a second round injection of an ultra fine or micro file OPC slurry material. The OPC slurry injected into holes 32 will diffuse into the formation interior to the MOC material that was diffused into the formation though holes 12. The diffusion of the OPC slurry injected into holes 32 is depicted as at 34. Curing of the injected OPC slurry material will result in the creation of an interior low permeability zone 31 that extends outwardly from the tunnel surface several meters from the walls, ceiling and floor of the tunnel passage 20.

The perimeter low permeability zone 30 established by the MOC slurry acts to confine the diffusion or dispersion of the second round of grouting into the formation nearer to the tunnel passage 20. This results in less OPC grout being used in the second round of grouting as the OPC grout slurry of the second round will not be injected into a volume extending too far away from tunnel passage 20. The inner boundary region of the outer perimeter low permeability zone 30 proximal to the inner low permeability zone 31 also establishes a boundary region in the formation to ensure that there will be sufficient back pressure during the second round OPC slurry injection. A back pressure is required to allow the second round OPC injection to seal all fine cracks and to decrease formation porosity proximal to the tunnel passage 20. The back pressure will better ensure that the second round of grouting establishes a low permeability zone 31 that has a watertight construction.

Subsequent excavation and drilling steps to the two just described in detail are also shown in FIG. 8. For instance, excavation of the tunnel passage 20 continues to the location where the next perimeter low permeability zone holes 32a will be drilled. The holes 32a are off set from previously drilled holes 12a. The excavation depth to the location where holes 32a are to be drilled is preferably 5 meters of further tunnel passage excavation construction from holes 12a. The injection of an MOC slurry into holes 32a will diffuse into the formation as shown by 34a. This process is repeated for holes 12b and associated slurry diffusion 22b; holes 32b and associated OPC slurry diffusion 34b.

2. Multi-grout—Post Grouting System

Another application of the multi-grout formation grouting system of the present invention is for formation treatment in the volume surrounding a pre-existing excavation. This application is referred to as a post-grouting system. Use of the methodology results in the creation of a uniform low permeability zone in the treated volume of the formation. The actual grouting procedure employed will depend on the characteristics or type of materials found in the formation and the formation in-situ permeability. The formation characteristics will dictate the actual drill pattern and type of materials required to create this uniform low permeability zone.

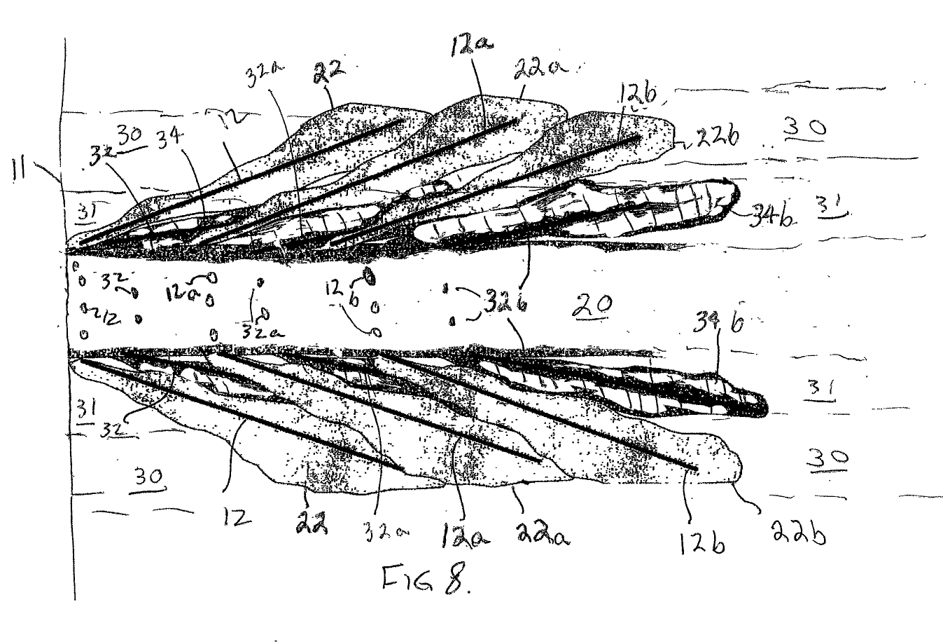

FIG. 9 shows a cross section of a profile of a subterranean tunnel which has been constructed in an earthen formation. In a post-grouting application, a grouting slurry is applied to the formation volume surrounding the construction, for example a tunnel 20, to establish a low permeability zone in the volume surrounding the existing excavation. The low permeability zone will be established to seal the rock fractures and reduce porosity of the formation. The grouting is supplied to the formation, generally depicted by reference numeral 10, via holes or bores 12 which are drilled into the formation. In the post-grouting application, all bores or holes 12 are drilled along the surface 18 of the excavated area. The hole spacing 16 is selected to allow for pressure injection application of the grouting slurry materials into the formation through holes 12 to enable the grouting to be applied to establish a sufficient thickness to prevent or to reduce subsequent grout injection leakage into the tunnel passage 20. The first round of grouting is to seal the volume proximal to the excavation, for example tunnel passage 20 to reduce leakage of grout material when the second round of injection is performed.

Post-grouting of an existing underground construction involves drilling of holes 12 into all the surrounding rock faces i.e. front, walls, ceiling and floor of the excavation. The number of holes 12 that are to be drilled will naturally depend on the perimeter or length of the boundary that defines the tunnel wall 18 and will also depend on the earthen material found in the formation. Because injection pressures can range from 30 to 70 bar, it is preferable to ensure that the spacing 16 between adjacent holes at the tunnel wall 18 is not less than 0.4 meters to ensure that sufficient formation material is present between adjacent bores to withstand the forces created by the injection pressures. Once holes 12 are drilled, the first grout material is injected under pressure to establish a low porosity zone to seal cracks and reduce formation porosity. Injection of the grout material also acts to consolidate the rock formation and improve its structural integrity. Thus the first round grouting will further stabilise the subterranean formation proximal to the tunnel surface.

This invention employs specific methodology relating to a multi-grout pre-grouting system. In a pre-grouting procedure, injection holes 12 are drilled all around the intended perimeter of the construction, for example a tunnel. The holes 12 are drilled to a length extending from four to fifty meters. The holes 12 are drilled at different angles, or fan out direction, that depends on the local formation conditions. The holes 12 are of a length sufficient to enable grouting material supplied there through to create the uniform low permeability zone in the formation of the thickness required to minimise fluid flows into the excavation or construction. In practice, it is expected to drill a total of five to sixty holes depending on the formation permeability, formation water pressure and the desired or permitted leakage. The injection holes 12 are spaced approximately not less than forty centimeters apart into the front and along the future theoretical wall 18. The drilling along the excavation boundary 18 creates a ring or round around the entire circumference of the tunnel. Once the holes 12 are drilled, injection of the slurry can start. For best results, slurry injection can start at the bottom of the tunnel 20, but this can vary depending on local conditions.

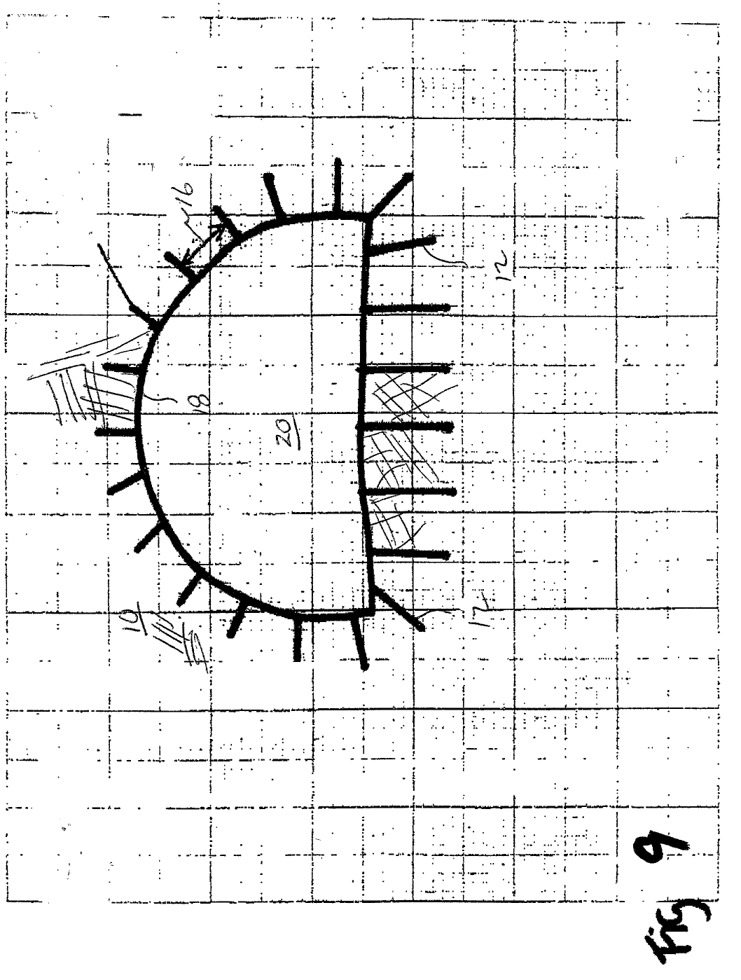

FIG. 10 shows a the slurry dispersion of the first round of injection. The first round of injection of the MOC slurry will diffuse into the formation as shown at 22. When the slurry cures, it will establish an interior low permeability zone 31 that extends outwardly five to ten meters from the perimeter wall 18 of the tunnel. The interior low permeability zone 31 prevents dispersion of the next round of grouting into the excavation 20. The interior low permeability zone 31 thus establishes a boundary region in the formation to assist in creating the necessary back pressure required to allow the second round injection to seal any fine cracks and porosity to better ensure that the second round of grouting establishes a low permeability zone having a watertight construction.

The controlled setting characteristics, obtained by the first round injection of the MOC slurry, enables the second round of grouting, which commences with injection of a micro fine or ultra fine OPC slurry outside the interior low permeability zone 31, to start with minimal delay. When the first round injection of the MOC slurries has had enough time to cure to establish sufficient strength development (usually within two hours) the second round of injection incorporating a micro fine or ultra file OPC slurry can begin.

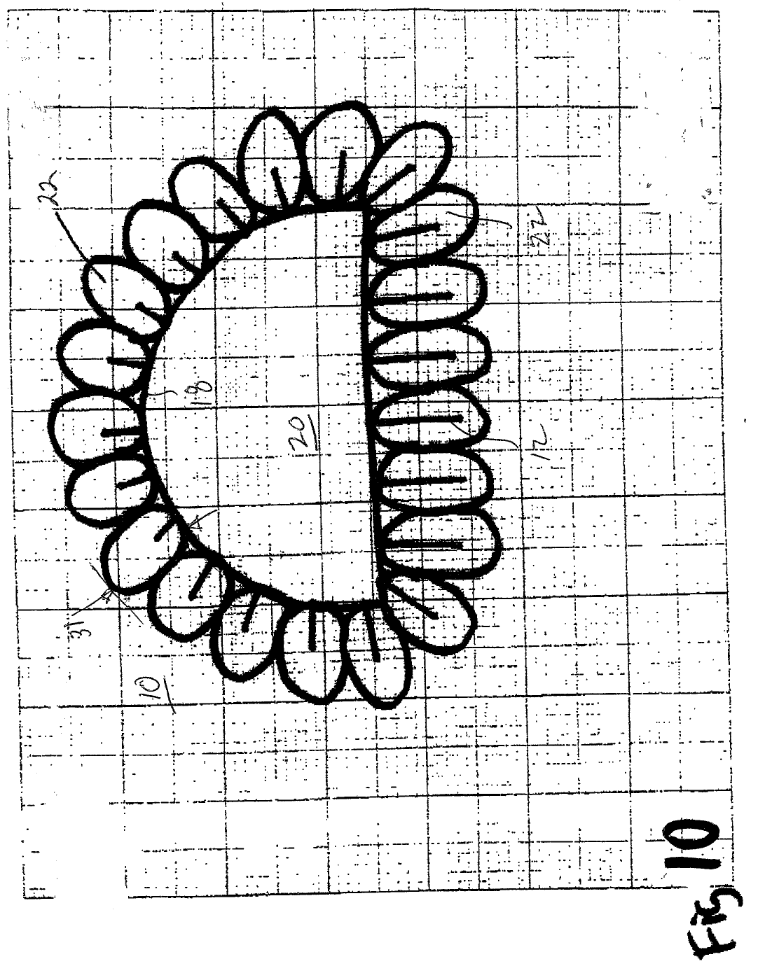

FIG. 11 shows the set up for the second round of injection. To commence the second round injection, additional holes 32 are drilled in an offsetting pattern from the holes 12 of the first injection round. The second round injection holes 32 preferably have a depth, that is two to three meters more than the depth of the first round injection holes 12 which were drilled to create the interior low permeability zone. It is preferable to begin injection of the grouting at the bottom of the construction zone and progress systematically upwards to the top of the construction zone.

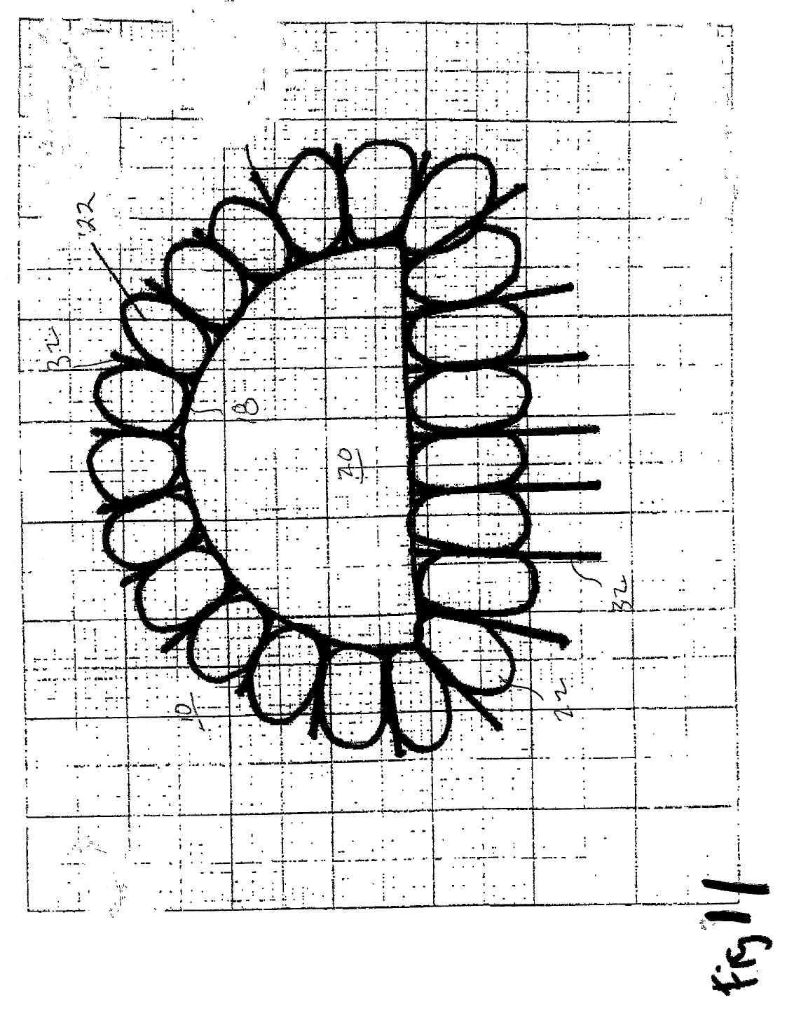

FIG. 12 shows that the injection of the OPC grouting slurry will cause the slurry to diffuse or permeate into the formation, as shown at 34. Injection of the micro fine or ultra fine OPC slurry continues until a predetermined pressure or refusal rate is achieved.

If desired, an MOC slurry grouting material can next be injected into the bores 32 following the OPC slurry injection. The purpose of this final filling with an MOC slurry is to accelerate the curing or setting of the injected OPC slurry 34. When the MOC slurry is injected into the bores 32, it will intermix with the previously injected OPC slurry. The intermixing of the slurries will induce accelerated curing or setting or hardening which will reduce the time needed before the OPC slurry is prevented from being expelled back out of the injection holes 32.

If significant water inflow is encountered during the drilling of the injection holes, 12 or 32, a sequential injection of an OPC slurry followed by an injection of an MOC slurry into each hole or bore 12 is used. This sequential drill/injection procedure preferably utilises two slurry pumps 26, one for the MOC and the other for the OPC. It is preferable to have two slurry pumps on hand in any event to avoid the repeated need to clean and set up the slurry pump each time. This procedure may need to be repeated several times to allow the acceleration of the setting of the two grouts to fill and seal the water producing fracture. Additional graded sized fillers including sand may also be included in the slurry in conjunction with the grouting procedures to stem water inflow.

The resulting effect of this system will be a low permeability overlapping seal of the formation surrounding tunnel passage 20.

3. Multi-grout—Dam Grouting System

Construction relating to dam projects involves building a berm to raise the hydrostatic level of water of to form a reservoir. Dams are normally constructed across river valleys. When the dam is completed, the hydrostatic level of the water in the reservoir can be several hundred feet high. The berm of the dam is constructed on the base of the river valley, often on moraine tills or other weak geological formations. It is an objective to extend the core of the berm forming dam, which is usually asphalt or moraine, to a depth equivalent to seventy to eighty percent of the hydrostatic level of the water in the reservoir. To define and confine this extension of the core, a low permeability barrier formed by a grout curtain established along the length of the core of the berm forming the dam. In this use of the system of the invention, MOC and OPC are used to create a uniform permeability zone underneath the berm of the dam.

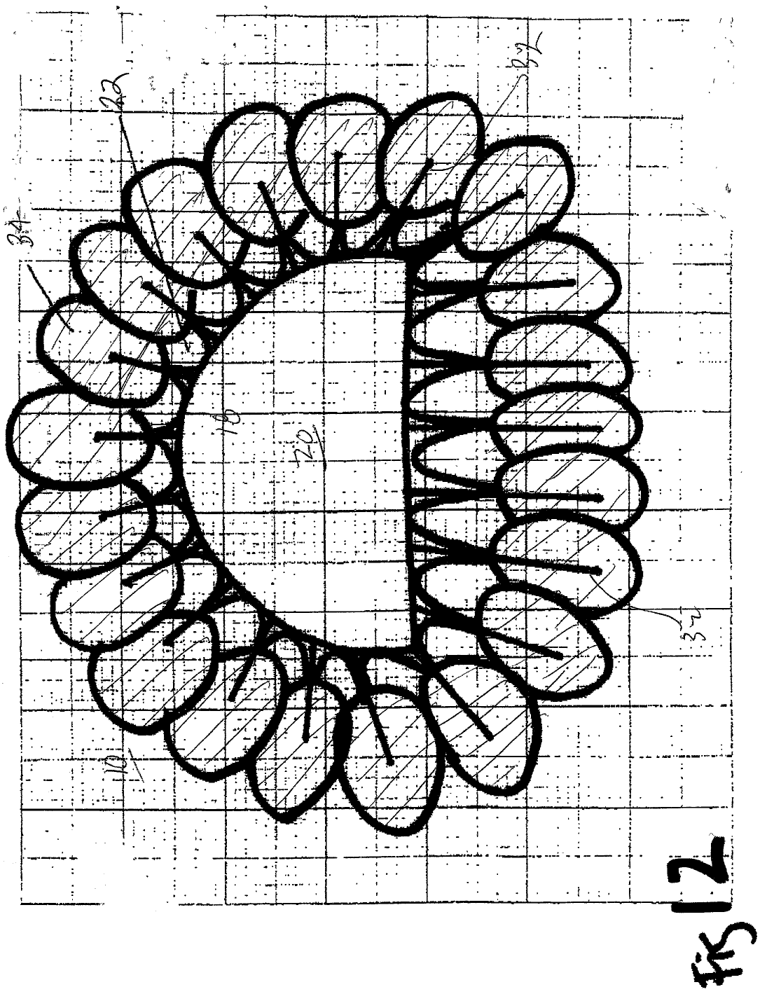

FIG. 13 shows a cross section of a river valley. The river valley surface 60 will form the lower support base for a berm to be constructed to form a dam thereover. The dam will produce a reservoir having a water level 62. Injection holes 64 are drilled to a depth equivalent to seventy to eighty percent of the hydrostatic column at the water lever 62 of the reservoir above each respective injection hole 64. Thus at the lowest extremity of the river valley surface 60, the hydrostatic water level “H” will have a corresponding bore 64 drilled to a depth “D” where the depth “D” will be seventy to eighty percent of the overbearing hydrostatic water level “H”.

These injection holes 64 will be drilled in a row along the entire length of the base of the berm that will form the dam. The spacing of the holes 64 will be dependent on the in-situ permeability of the formation into which the low permeability barrier is to be formed. Depending upon local conditions, a pre-grouting program previously discussed may need to be implemented. Otherwise, grout lines 27 will be placed in the injection holes 64 with a packer 24 initially set up to five meters from the bottom of the injection hole 64. An MOC grout slurry 22 will be injected from slurry pump 26 through the grout line 27, past the packer 24 to permeate into the formation. The supply of the MOC grout slurry will continue until a predetermined injection pressure is reached. The predetermined injection pressure will depend on local formation conditions into which the grout is being injected. Typical injection pressures will range from 20 to 70 tor. In this manner and upon reaching the predetermined injection pressure, a uniform permeability zone will be established when the injected grout slurry cures. Next, the packer 24 will be pulled up the hole 64, for a distance that will depend upon the formation in situ permeability, and reset or sealed at the new location. Injection of the MOC slurry is then re-commenced and continues again until the predetermined injection pressure is reached. This procedure is repeated until the injection of MOC slurry is performed with the packer 24 set at the surface of the injection hole 64. This process is performed for each of the holes 64 lying across the river bed 60 lying below the reservoir.

Once MOC grouting has been performed in all of the holes 64, an MOC grout curtain will be formed. The MOC grout curtain will provide the necessary back pressure required for the final pressure injection grouting of the formation using and OPC slurry to form a uniform low permeability zone. When the OPC grout is supplied under pressure it will act to seal the formation cracks and reduce the formation porosity and unconsolidated zones. To effect OPC grouting, offsetting injection holes will be drilled throughout the entire section of the MOC grout curtain.

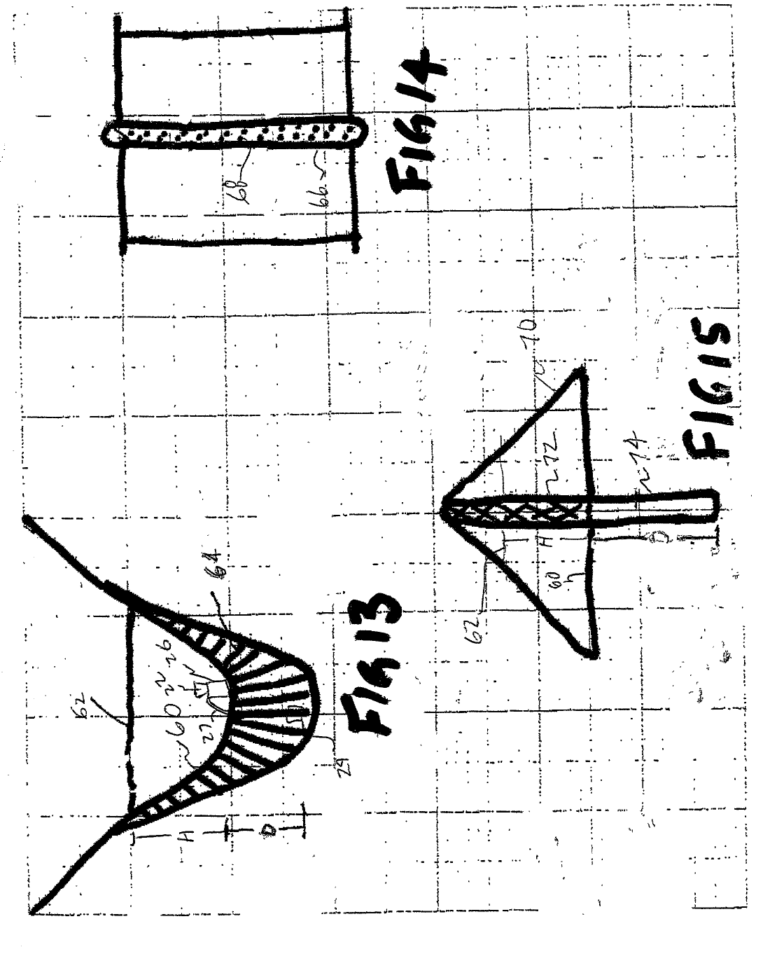

FIG. 14 shows a top view of the river valley of FIG. 13. The MOC grout curtain 66 has a plurality of offsetting injection holes 68 drilled throughout the entire length of the MOC grout curtain 66. The depth of these injection holes 68 will correspond to the length of each of the proximal first injection holes 64 that were drilled to form the grout curtain 66 as was described with reference to FIG. 13. The pattern of the offsetting injection holes 68 will ensure complete overlap of the MOC and OPC grouting and is optimum for extension of the overall grout curtain that will be formed when OPC slurry is injected under pressure into the bores 68. The injection program and packer placement to injected the OPC grout slurry into holes 68 is the same as was employed for the MOC injection procedure. Multiple grouting lines may be implemented to optimise the grouting operation.

FIG. 15 is a cross section side view of showing dam built over a grout curtain formed as described with reference to FIGS. 13 and 14. A dam berm 70 is built to a height to support a reservoir having a water level “H”. The centre of berm 79 includes an asphalt or moraine core 72. In the formation below the dam core 72 is a grout curtain 74 which extends to a depth “D” below the river bed surface 60 that supports the berm 70. Grout curtain 74 includes both MOC and OPC grout materials that have been injected into the river bed formation in the manner described with reference to FIGS. 13 and 14.

Now that the invention has been disclosed, numerous modifications, substitutions and mechanical equivalents may occur to those skilled in the art. The spirit and scope of the invention is defined in the claims appended hereto.

We claim:

1. A method of treating a subterranean formation comprising:
(a) forming at least one bore extending into a subterranean formation;
(b) supplying under pressure a magnesium oxychloride cementitious grout slurry to each said bore;
(c) forming a correspondingly disposed bore for each said bore of step (a) extending into said subterranean formation; and
(d) supplying under pressure an ordinary Porland cementitious grout slurry to each said correspondingly disposed bore.

2. The method of claim 1 further including the step of supplying under pressure a magnesium oxychloride cementitious grout slurry to each said correspondingly disposed bore.

3. The method of claim 1 wherein said magnesium oxychloride cementitious grout slurry is a mixture of water and magnesium oxychloride cement mixed in a ratio of 1:4 to 6:1 by volume.

4. The method of claim 1 wherein said ordinary Portland cementitious grout slurry is a mixture of water and ordinary Portland cement mixed in a ratio of 1:4 to 6:1 by volume.

5. The method of claim 3 wherein said magnesium oxychloride cemetitious grout slurry includes silica fume in quantities of up to 80% by weight of the magnesium oxychloride cement and water constituents of the slurry mixture.

6. The method of claim 4 wherein said ordinary Portland cemenitious grout slurry includes silica fume in quantities of up to 80% by weight of the ordinary Portland cement and water constituents of the slurry mixture.

7. A method of producing a low permeability zone in a subterranean formation surrounding a volume for excavation comprising:
(a) forming a plurality of bores extending into a subterranean formation, surrounding and extending outwardly a first selected distance from a predefined volume;
(b) supplying under pressure a magnesium oxychloride cementitious grout slurry to each said bore;
(c) excavating a selected distance into the portion of said subterranean formation surrounded by the bores formed in step (a) which is not more than one half of the depth of said bores to form an excavated front;
(d) at the location of said excavated front, forming a correspondingly disposed bore for each said bore of step (a) extending into said subterranean formation surrounding and extending outwardly a second selected distance from said predefined volume, which second selected distance is less than said first selected distance; and
(e) supplying under pressure an ordinary Portland cementitious grout slurry to each said correspondingly disposed bore.

8. The method of claim 7 wherein said correspondingly disposed bore is offset from each said bore of step (a) of claim 7 to produce an off-set pattern therebetween.

9. The method of claim 7 further including the step of supplying under pressure a magnesium oxychloride cementitious grout slurry to each said correspondingly disposed bore.

10. The method of claim 7 wherein said magnesium oxychloride cementitious grout slurry is a mixture of water and magnesium oxychloride cement mixed in a ratio of 1:4 to 6:1 by volume.

11. The method of claim 7 wherein said ordinary Portland cementitious grout slurry is a mixture of water and ordinary Portland cement mixed in a ratio of 1:4 to 6:1 by volume.

12. The method of claim 10 wherein said magnesium oxychloride cementitious grout slurry includes silica fume in quantities of up to 80% by weight of the magnesium oxychloride cement and water constituents of the slurry mixture.

13. The method of claim 11 wherein said ordinary Portland cementitious grout slurry includes silica fume in quantities of up to 80% by weight of the ordinary Portland cement and water constituents of the slurry mixture.

14. A method of producing a low permeability zone in a subterranean formation surrounding an excavated volume comprising:
(a) forming a plurality of bores extending into a subterranean formation, surrounding and extending outwardly a first selected distance from an excavated volume;
(b) supplying under pressure a magnesium oxychloride cementitious grout slurry to each said bore;
(c) longitudinally displaced a selected distance along said excavation from the bores formed in step (a) which is not more than one half of the depth of said bores, forming a correspondingly disposed bore for each said bore of step (a), the correspondingly disposed bore extending into said subterranean formation surrounding and extending outwardly a second selected distance from said excavated volume, which second selected distance is greater than said first selected distance; and
(d) supplying under pressure an ordinary Portland cementitious grout slurry to each said correspondingly disposed bore.

15. The method of claim 14 wherein said correspondingly disposed bore is offset from each said bore of step (a) of claim 14 to produce an off-set pattern therebetween.

16. The method of claim 14 further including the step of supplying under pressure a magnesium oxychloride cementitious grout slurry to each said correspondingly disposed bore following the step of supplying under pressure an ordinary Portland cementitious slurry.

17. The method of claim 14 wherein said magnesium oxychloride cementitious grout slurry is a mixture of water and magnesium oxychloride cement mixed in a ratio of 1:4 to 6:1 by volume.

18. The method of claim 14 wherein said ordinary Portland cementitious grout slurry is a mixture of water and ordinary Portland cement mixed in a ratio of 1:4 to 6:1 by volume.

19. The method of claim 17 wherein said magnesium oxychloride cementitious grout slurry includes silica fume in quantities of up to 80% by weight of the magnesium oxychloride cement and water constituents of the slurry mixture.

20. The method of claim 18 wherein said ordinary Portland cementitious grout slurry includes silica fume in quantities of up to 80% by weight of the ordinary Portland cement and water constituents of the slurry mixture.

21. A mixture for treatment of a subterranean formation comprising:
(a) a first slurry of ordinary Portland grout produced from mixing water and ordinary Portland cement mixed in a ratio of 1:4 to 6:1 by volume; mixed with
(b) a second slurry of magnesium oxychloride grout produced from mixing water and magnesium oxychloride cement mixed in a ratio of 1:4 to 6:1 by volume.

22. The mixture of claim 21 further including:
(a) silica fume in quantities of up to 80% by weight of the mixture constituents of ordinary Portland cement, magnesium oxychloride cement and water of each respective slurry.

23. A method of creating a low permeability zone in a subterranean formation containing water under pressure comprising:
(a) forming a bore into the formation;
(b) supplying under pressure a volume of an ordinary Portland cementitious grout slurry to the bore; and
(c) supplying under pressure a substantially similar volume of a magnesium oxychloride cementitious grout slurry to the bore.
